(19) United States
(12) Patent Application Publication
(10) Pub. No.: US 2023/0204767 A1
(43) Pub. Date: Jun. 29, 2023

(54) DUAL-BAND ULTRASONIC SENSING APPARATUS FOR VEHICLES AND CONTROL METHOD THEREOF

(71) Applicant: HYUNDAI MOBIS CO., LTD., Seoul (KR)

(72) Inventor: Jae Young LEE, Yongin-si (KR)

(73) Assignee: HYUNDAI MOBIS CO., LTD., Seoul (KR)

(21) Appl. No.: 17/821,742

(22) Filed: Aug. 23, 2022

(30) Foreign Application Priority Data
Dec. 27, 2021 (KR) 10-2021-0188613

(51) Int. Cl. G01S 15/931; G01S 15/04; G01S 15/87; G01S 15/89; G01S 7/52; G01S 7/53

(52) U.S. Cl. CPC G01S 15/931; G01S 15/04; G01S 15/87; G01S 15/8952; G01S 7/52015; G01S 7/53

(57) ABSTRACT

A dual-band ultrasonic sensing apparatus for vehicles and a control method thereof. The dual-band ultrasonic sensing apparatus includes a first waveform transceiver configured to transmit and receive ultrasound in a first center frequency band, a second waveform transceiver configured to transmit and receive ultrasound in a second center frequency band higher than the first center frequency band, a processor configured to sequentially transmit and receive ultrasonic waves through the first and second waveform transceivers, to calculate each distance based on the result of transmission and reception by compensating for signal attenuation due to a difference in center frequency, and to calculate a final distance by determining whether to detect an obstacle through each calculated distance, and an output unit configured to output the final distance calculated by the processor.

### CROSS-REFERENCE TO RELATED APPLICATION

This application claims priority from and the benefit of Korean Patent Application No. 10-2021-0188613, filed on Dec. 27, 2021, which is hereby incorporated by reference for all purposes as if set forth herein.

### BACKGROUND

### Field

Exemplary embodiments of the present disclosure relate to a dual-band ultrasonic sensing apparatus for vehicles and a control method thereof, and more particularly, to a dual-band ultrasonic sensing apparatus for vehicles and a control method thereof, which are capable of sequentially transmitting dual-band ultrasonic signals with different center frequencies and then receiving the transmitted dual-band ultrasonic signals in sequence through bandpass filters, so as to stably detect an obstacle without affecting the previously transmitted signals by compensating for attenuation due to changes in the center frequencies.

### Discussion of the Background

In general, a front and rear sensing system is mounted on a vehicle to prevent a collision accident by notifying the vehicle in advance that there is an obstacle when the vehicle moves forward or backward. The front and rear sensing system is also referred to as a front warning system, a rear warning system, or a rear-side warning system. In addition, a parking assistance system or a parking assist system has the same concept as the front and rear sensing system.

The front and rear sensing system refers to a system that detects an obstacle in front of or behind a vehicle when the vehicle is parked or moved forward or backward for any other reasons.

Typically, the sensing system includes two to four ultrasonic sensors mounted and operated on the front and rear bumpers of the vehicle, and additionally includes a separate sensor operated to enable additional parking assistance in some vehicles. The sensing system is operated in various ways, such as receiving a signal generated from one ultrasonic sensor by the same ultrasonic sensor or by another ultrasonic sensor disposed adjacent thereto.

In this case, the ultrasonic sensor used as the vehicle rear sensor mainly transmits an ultrasonic signal (Tx) having a specific single frequency in a band of 40 to 60 kHz, and then receives an ultrasonic signal (Rx) reflected by a person or an object.

That is, conventionally, a single ultrasonic sensor or the same ultrasonic sensor is used for ultrasonic transmission and reception to detect a distance by detecting a transmission/reception time for which an ultrasonic signal is transmitted and then received following reflection from an object.

The related art of the present disclosure is disclosed in Korean Patent No. 10-1699307 (issued on Jan. 24, 2017), entitled “Self-Identifying Ultrasonic Sensor System & Self-Signal Determination Method Using The Same”.

As described above, the ultrasonic sensor detects whether an ultrasonic signal having a single frequency is transmitted and then received (Rx) following reflection from an object. Hence, if vehicles equipped with ultrasonic sensors using the same band travel adjacently, they may be affected by interference, as well as noise from a fluorescent lamp ballast that produces a sound wave in that band, a garage air gun, or a bus starting sound.

Moreover, since the sound wave uses air as a medium, it may cause false detection due to cross wind or vortexes.

Therefore, in order to reduce environmental sensitivity, the vehicle ultrasonic sensor uses a method of recognizing a received waveform as an obstacle only when the received waveform is present at the same location through transmission/reception in twice.

Although this method has a doubled detection period, it is possible to reduce a probability of false detection of the ultrasonic sensor by effectively improving a random noise effect because only a signal detected twice in succession is recognized as an obstacle.

However, since the transmission/reception is performed twice in succession, a first transmitted signal may affect a second transmission/reception process.

For example, the first transmitted signal may be reflected from a distant strong reflector such as a wall, and received at a second time of transmission/reception. In this case, recognition is not always possible since the object detected in the first transmission/reception process is located at a position different from the wall waveform received in the second transmission/reception process.

Therefore, in order to solve this issue, the ultrasonic sensor may have an increased operation period. That is, the size of the ultrasonic sensor is inversely proportional to the cube of the distance. Accordingly, if the period is increased, only a signal reflected from an object at a greater distance is received at the second time of transmission/reception.

Therefore, since the magnitude of the first signal that arrives at the second time of transmission/reception is smaller than an object-ground separation threshold value, it does not affect object detection.

However, use of the method of increasing the operation period increases an obstacle detection period. Hence, it is difficult to detect a moving object and the number of times of detection is reduced, resulting in deterioration of reliability.

### SUMMARY

Various embodiments are directed to a dual-band ultrasonic sensing apparatus for vehicles and a control method thereof, which are capable of sequentially transmitting dual-band ultrasonic signals with different center frequencies and then receiving the transmitted dual-band ultrasonic signals in sequence through bandpass filters, so as to stably detect an obstacle without affecting the previously transmitted signals by compensating for attenuation due to changes in the center frequencies.

In an embodiment, there is provided a dual-band ultrasonic sensing apparatus for vehicles, which includes a first waveform transceiver configured to transmit and receive ultrasound in a first center frequency band, a second waveform transceiver configured to transmit and receive ultrasound in a second center frequency band higher than the first center frequency band, a processor configured to sequentially transmit and receive ultrasonic waves through the first and second waveform transceivers, to calculate each distance based on the result of transmission and reception by compensating for signal attenuation due to a difference in center frequency, and to calculate a final distance by determining whether to detect an obstacle through each calculated distance, and an output unit configured to output the final distance calculated by the processor.

The processor may include an attenuation compensator configured to compensate for attenuation of the ultrasound transmitted and received through the second waveform transceiver, a distance calculator configured to calculate a first distance based on the result of transmission and reception of the first waveform transceiver, and to calculate a second distance based on the result of transmission and reception of the second waveform transceiver compensated for by the attenuation compensator, and an obstacle determiner configured to determine whether to detect an obstacle based on the difference between the first distance and the second distance calculated by the distance calculator.

The attenuation compensator may compensate for the attenuation through a variable amplification factor to which an attenuation coefficient corresponding to the difference in center frequency is applied.

The obstacle determiner may determine that the obstacle is detected when the difference between the first distance and the second distance is less than a set value.

The processor may calculate the final distance by averaging the calculated distances.

The first waveform transceiver may include a bandpass filter to filter a first center frequency.

The second waveform transceiver may include a bandpass filter to filter a second center frequency.

In another embodiment, there is provided a method of controlling a dual-band ultrasonic sensing apparatus for vehicles, which includes transmitting and receiving, by a processor, ultrasound in a first center frequency band through a first waveform transceiver, calculating, by the processor, a first distance based on the result of transmission and reception through the first waveform transceiver, transmitting and receiving, by the processor, ultrasound in a second center frequency band higher than the first center frequency band through a second waveform transceiver, compensating for, by the processor, signal attenuation due to a difference in center frequency based on the result of transmission and reception through the second waveform transceiver, calculating, by the processor, a second distance based on the result of transmission and reception with the compensation for signal attenuation, determining, by the processor, whether to detect an obstacle based on the difference value between the first distance and the second distance, and calculating and outputting, by the processor, a final distance based on the result of determination of whether to detect an obstacle.

In the compensating for, by the processor, signal attenuation, the processor may compensate for the attenuation through a variable amplification factor to which an attenuation coefficient corresponding to the difference in center frequency is applied.

In the determining, by the processor, whether to detect an obstacle, the processor may determine that the obstacle is detected when the difference between the first distance and the second distance is less than a set value.

In the calculating and outputting, by the processor, a final distance, the processor may calculate the final distance by averaging the first distance and the second distance.

As apparent from the above description, the dual-band ultrasonic sensing apparatus for vehicles and the control method thereof according to the present disclosure can sequentially transmit dual-band ultrasonic signals having different center frequencies and then receive the transmitted dual-band ultrasonic signals in sequence through the bandpass filters, so as to stably detect an obstacle without affecting the previously transmitted signals by compensating for attenuation due to the changes in the center frequencies to separate the ground from the object with the same threshold value. In addition, it is possible to shorten an operation period since each transmission/reception process is performed independently, which makes it possible to effectively detect a moving object and to increase the number of times of detection, thereby enhancing reliability.

### BRIEF DESCRIPTION OF THE DRAWINGS

FIG. 1 is a block diagram illustrating a dual-band ultrasonic sensing apparatus for vehicles according to an embodiment of the present disclosure.

FIGS. 2A-2B are views illustrating a spatial beam pattern change depending on the change in center frequency in the dual-band ultrasonic sensing apparatus for vehicles according to the embodiment of the present disclosure.

FIGS. 3A-3D illustrate a waveform indicative of a comparison in magnitude between a previous signal and a received signal during a transmission/reception process and a previous signal in the dual-band ultrasonic sensing apparatus for vehicles according to the embodiment of the present disclosure.

FIG. 4 is a flowchart for explaining a method of controlling a dual-band ultrasonic sensing apparatus for vehicles according to another embodiment of the present disclosure.

### DETAILED DESCRIPTION OF THE ILLUSTRATED EMBODIMENTS

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereinafter, a dual-band ultrasonic sensing apparatus for vehicles and a control method thereof according to the present disclosure will be described with reference to the accompanying drawings. It should be considered that the thickness of each line or the size of each component in the drawings may be exaggeratedly illustrated for clarity and convenience of description. In addition, the terms used herein are terms defined in consideration of functions of the present disclosure, and these terms may change depending on the intention or practice of a user or an operator. Therefore, these terms should be defined based on the entirety of the disclosure set forth herein.

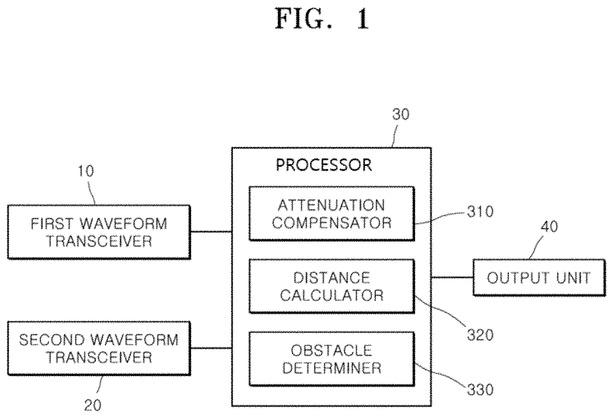

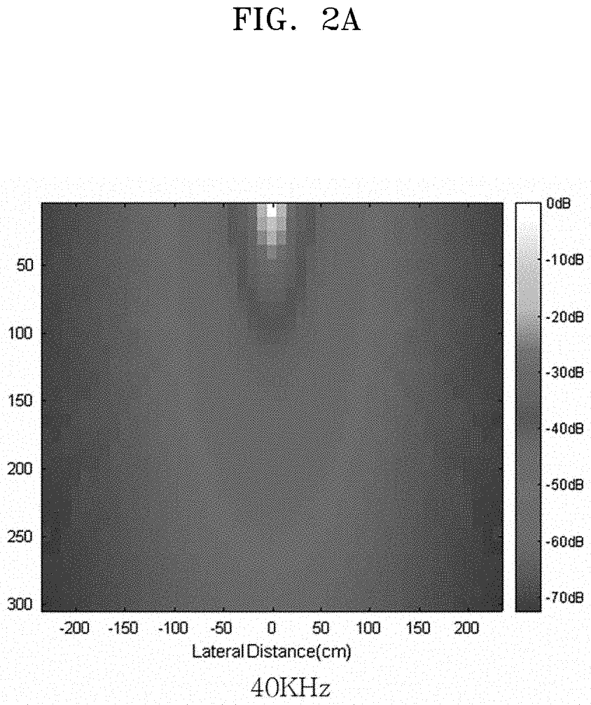

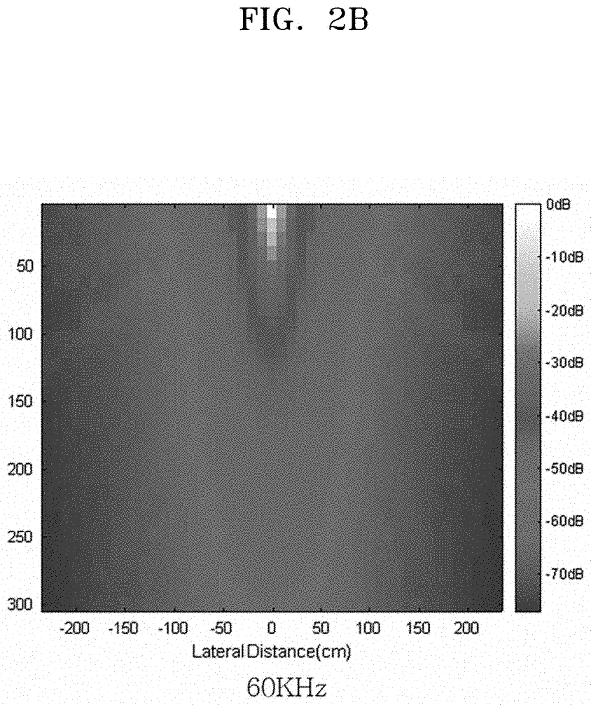

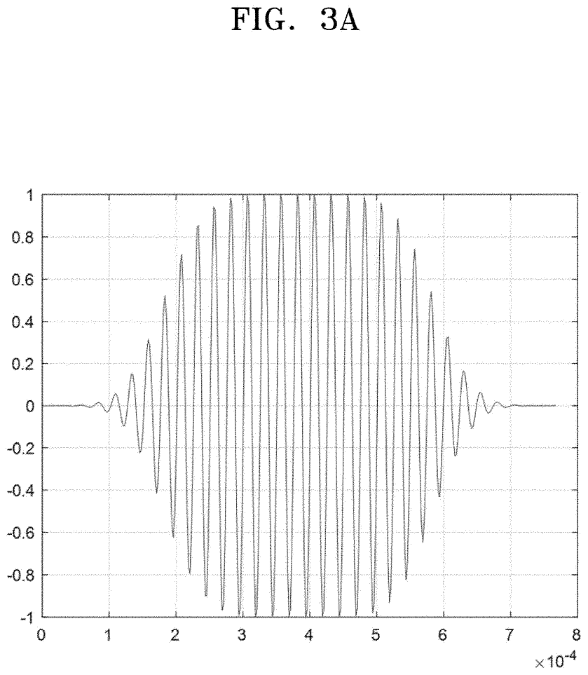

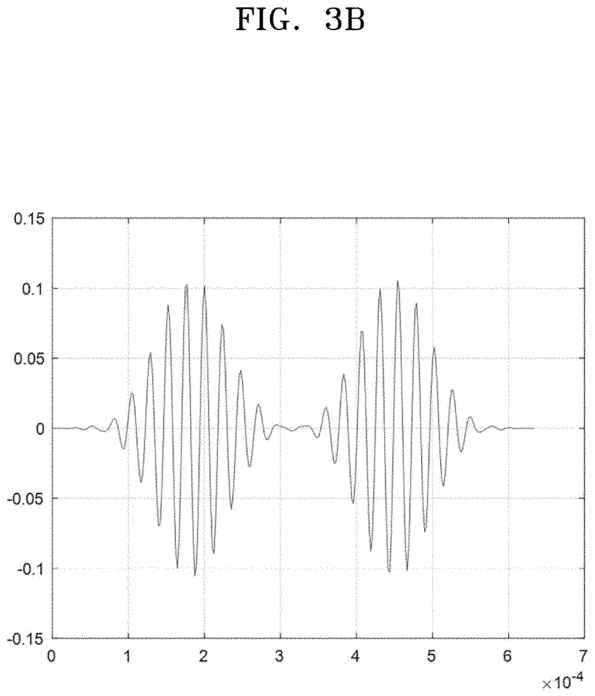

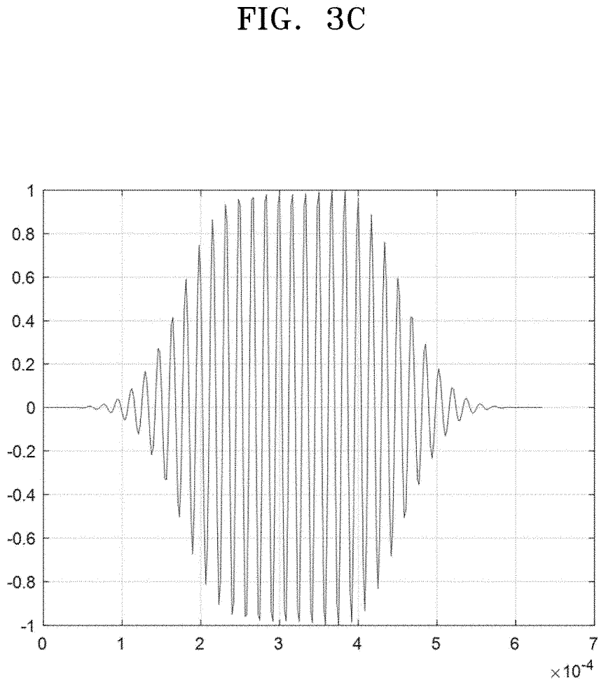

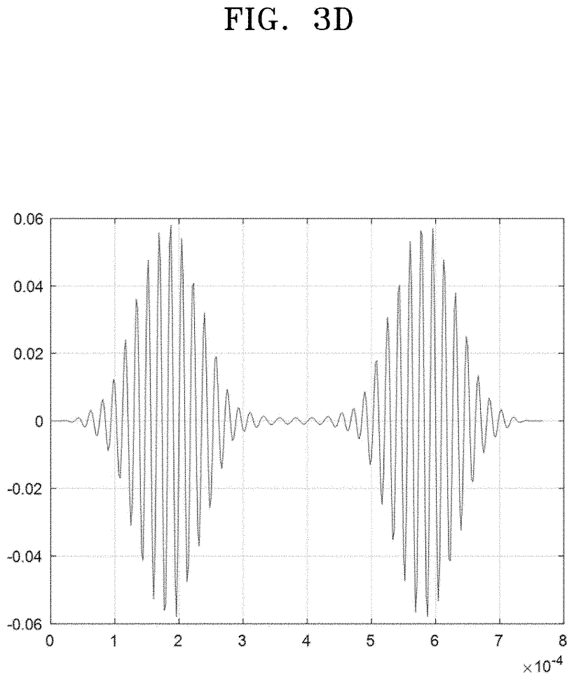

FIG. 1 is a block diagram illustrating a dual-band ultrasonic sensing apparatus for vehicles according to an embodiment of the present disclosure. FIGS. 2A-2B are views illustrating a spatial beam pattern change depending on the change in center frequency in the dual-band ultrasonic sensing apparatus for vehicles according to the embodiment of the present disclosure. FIGS. 3A-3D illustrate a waveform indicative of a comparison in magnitude between a previous signal and a received signal during a transmission/reception process and a previous signal in the dual-band ultrasonic sensing apparatus for vehicles according to the embodiment of the present disclosure.

As illustrated in FIG. 1, the dual-band ultrasonic sensing apparatus for vehicles according to the embodiment of the present disclosure may include a first waveform transceiver 10, a second waveform transceiver 20, a processor 30, and an output unit 40.

The first waveform transceiver 10 may transmit and receive ultrasound in a first center frequency band.

In this case, the first waveform transceiver 10 includes a bandpass filter to filter a first center frequency.

The second waveform transceiver 20 may transmit and receive ultrasound in a second center frequency band higher than the first center frequency band.

In this case, the second waveform transceiver 20 includes a bandpass filter to filter a second center frequency.

In the present embodiment, the first center frequency is set to 40 kHz and the second center frequency is set to 60 kHz in order to use a broadband ultrasonic transducer.

Accordingly, the first waveform transceiver 10 has a bandpass filter pass band of 38 kHz to 42 kHz, and the second waveform transceiver 20 has a bandpass filter pass band of 58 kHz to 62 kHz.

The processor 30 may be configured to sequentially transmit and receive ultrasonic waves through the first and second waveform transceivers 10 and 20, to calculate each distance based on the result of transmission and reception by compensating for signal attenuation due to the difference in center frequency, and to calculate a final distance by determining whether to detect an obstacle through each calculated distance.

The processor 30 may include an attenuation compensator 310, a distance calculator 320, and an obstacle determiner 330.

The attenuation compensator 310 may compensate for attenuation of the ultrasound transmitted and received through the second waveform transceiver 20.

In this case, the attenuation compensator 310 may compensate for attenuation through a variable amplification factor to which an attenuation coefficient corresponding to the difference between the first center frequency and the second center frequency is applied.

Ultrasound has low environmental sensitivity, which means that the change in frequency will change the attenuation coefficient in the air. For example, at 25° C., 50% RH, and 1 atmosphere, the attenuation coefficient at 40 kHz is 1.3182 dB/m, while the attenuation coefficient at 60 kHz is 1.98 dB/m. Thus, in order to use 60 kHz when a threshold value is set using the frequency of 40 kHz, a variable amplification factor of 1.3236 dB/m slope may be applied to compensate for signal reduction.

In addition, a beam angle decreases as a beam pattern has an increased frequency according to the change in center frequency of the ultrasound, as illustrated in FIGS. 2A-2B. In an indirect measurement method, since an obstacle is detected at a midpoint between the first waveform transceiver 10 and the second waveform transceiver 20, an indirect measurement signal varies with the change in lateral beam pattern.

Therefore, the present embodiment uses 75 ϕ PVC with a length of 1 m in the stage of vehicle development to measure an object waveform at 40 kHz and 60 kHz in an longitudinal direction from the middle of the first waveform transceiver 10 and the second waveform transceiver 20, and uses a waveform amplitude ratio as the variable amplification factor to make it possible to use the same threshold value.

The distance calculator 320 may calculate a first distance ToF1 based on the result of transmission and reception of the first waveform transceiver 10, and calculate a second distance ToF2 based on the result of transmission and reception of the second waveform transceiver 20 compensated for by the attenuation compensator 310.

The obstacle determiner 330 may determine whether to detect an obstacle based on the difference between the first distance ToF1 and the second distance ToF2 calculated by the distance calculator 320.

That is, when the difference between the first distance ToF1 and the second distance ToF2 is less than a set value, the obstacle determiner 330 may determine that the obstacle is detected.

Accordingly, when the obstacle is detected, the processor 30 may calculate and output a final distance by averaging the first distance ToF1 and the second distance ToF2.

The output unit 40 may output the final distance calculated by the processor 30.

As described above, as it is seen from the waveform indicative of the comparison in magnitude between the previous signal and the received signal during the transmission/reception process in the dual-band ultrasonic sensing apparatus for vehicles, the transmission/reception process is not affected since the magnitude of the previously transmitted signal is reduced to one-tenth as illustrated in FIGS. 3A-3D.

That is, when the previously transmitted signal is received in the first transmission/reception process, the magnitude of the previously transmitted signal (FIG. 3B) received in the first transmission/reception process is reduced to one-tenth compared to that of the first transmission/reception signal (FIG. 3A). In addition, when the previously transmitted signal is received in the second transmission/reception process, the magnitude of the first transmitted signal (FIG. 3D) received in the second transmission/reception process is also reduced to one-tenth or less compared to that of the second transmission/reception signal (FIG. 3C).

Therefore, the magnitude of the signal reflected from an obstacle with high reflectivity such as a wall may be effectively reduced to a value smaller than the threshold value, which does not affect the transmission/reception process.

As described above, the dual-band ultrasonic sensing apparatus for vehicles according to the embodiment of the present disclosure can sequentially transmit dual-band ultrasonic signals having different center frequencies and then receive the transmitted dual-band ultrasonic signals in sequence through the bandpass filters, so as to stably detect an obstacle without affecting the previously transmitted signals by compensating for attenuation due to the changes in the center frequencies to separate the ground from the object with the same threshold value. In addition, it is possible to shorten an operation period since each transmission/reception process is performed independently, which makes it possible to effectively detect a moving object and to increase the number of times of detection, thereby enhancing reliability.

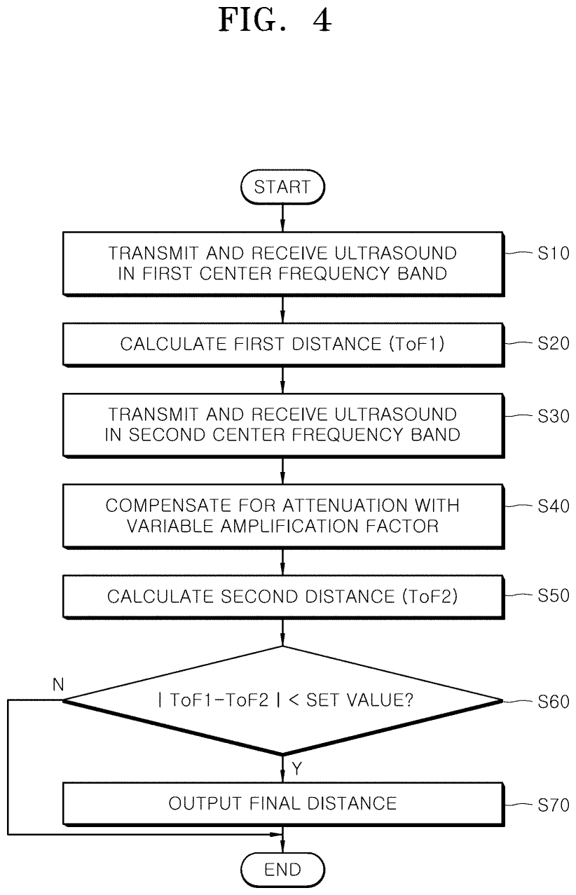

FIG. 4 is a flowchart for explaining a method of controlling a dual-band ultrasonic sensing apparatus for vehicles according to another embodiment of the present disclosure.

As illustrated in FIG. 4, in the method of controlling a dual-band ultrasonic sensing apparatus for vehicles according to the embodiment of the present disclosure, a processor 30 first transmits and receives ultrasound in a first center frequency band through a first waveform transceiver 10 (S10).

After transmitting and receiving the ultrasound in the first center frequency band in step S10, the processor 30 calculates a first distance ToF1 based on the result of transmission and reception (S20).

After calculating the first distance ToF1 in step S20, the processor 30 transmits and receives ultrasound in a second center frequency band higher than the first center frequency band through a second waveform transceiver 20 (S30).

In the present embodiment, a first center frequency is set to 40 kHz and a second center frequency is set to 60 kHz in order to use a broadband ultrasonic transducer.

Accordingly, the first waveform transceiver 10 has a bandpass filter pass band of 38 kHz to 42 kHz to receive the first center frequency, and the second waveform transceiver 20 has a bandpass filter pass band of 58 kHz to 62 kHz to receive the second center frequency.

The processor 30 compensates for signal attenuation due to the difference in center frequency based on the result of transmission and reception through the second waveform transceiver 20 in step S30 (S40).

In this case, the processor 30 may compensate for attenuation through a variable amplification factor to which an attenuation coefficient corresponding to the difference between the first center frequency and the second center frequency is applied.

Ultrasound has low environmental sensitivity, which means that the change in frequency will change the attenuation coefficient in the air. For example, at 25° C., 50% RH, and 1 atmosphere, the attenuation coefficient at 40 kHz is 1.3182 dB/m, while the attenuation coefficient at 60 kHz is 1.98 dB/m. Thus, in order to use 60 kHz when a threshold value is set using the frequency of 40 kHz, a variable amplification factor of 1.3236 dB/m slope may be applied to compensate for signal reduction.

After compensating for signal attenuation due to the difference in center frequency in step S40, the processor 30 calculates a second distance ToF2 based on the result of transmission and reception with the compensation for signal attenuation (S50).

After calculating the second distance in step S50, the processor 30 determines whether to detect an obstacle based on the difference between the first distance and the second distance (S60).

That is, when the difference between the first distance ToF1 and the second distance ToF2 is less than a set value, it may be determined that the obstacle is detected. On the other hand, when the difference between the first distance ToF1 and the second distance ToF2 exceeds the set value, it may be determined that no obstacle is detected so that the process is terminated.

When it is determined that the obstacle is detected in step S60, the processor 30 calculates and outputs a final distance by averaging the first distance ToF1 and the second distance ToF2 (S70).

As described above, the dual-band ultrasonic sensing apparatus for vehicles and the control method thereof according to the present disclosure can sequentially transmit dual-band ultrasonic signals having different center frequencies and then receive the transmitted dual-band ultrasonic signals in sequence through the bandpass filters, so as to stably detect an obstacle without affecting the previously transmitted signals by compensating for attenuation due to the changes in the center frequencies to separate the ground from the object with the same threshold value. In addition, it is possible to shorten an operation period since each transmission/reception process is performed independently, which makes it possible to effectively detect a moving object and to increase the number of times of detection, thereby enhancing reliability.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (e.g., an apparatus or program). The apparatus may be implemented in, for example, appropriate hardware, software, and firmware. The method may be implemented in, for example, an apparatus such as a processor, which refers to a processing device in general, including, for example, a computer, a microprocessor, an integrated circuit, or a programmable logic device. The processor also includes communication devices such as computers, cell phones, portable/personal digital assistants (“PDAs”), and other devices that facilitate communication of information between end-users.

While the present disclosure has been described with respect to the embodiments illustrated in the drawings, it will be obvious to those skilled in the art that such embodiments are provided by way of example only. It will be understood by those skilled in the art that various modifications and other equivalent embodiments may be made without departing from the spirit and scope of the disclosure as defined in the following claims.

Therefore, the technical protection scope of the present disclosure should be defined by the following claims.

What is claimed is:

1. A dual-band ultrasonic sensing apparatus for vehicles, comprising:
a first waveform transceiver configured to transmit and receive ultrasound in a first center frequency band;
a second waveform transceiver configured to transmit and receive ultrasound in a second center frequency band higher than the first center frequency band;
a processor configured to sequentially transmit and receive ultrasonic waves through the first and second waveform transceivers, calculate first and second distances based on a result of transmission and reception of the first and second waveform transceivers, respectively, by compensating for signal attenuation due to a difference in center frequency, and to calculate a final distance by determining whether to detect an obstacle through the calculated first and second distances; and
an output unit configured to output the final distance calculated by the processor.

2. The dual-band ultrasonic sensing apparatus according to claim 1, wherein the processor is configured to:
compensate for attenuation of the ultrasound transmitted and received through the second waveform transceiver;
calculate the first distance based on a result of transmission and reception of the first waveform transceiver;
calculate the second distance based on a result of transmission and reception of the second waveform transceiver compensated for by the attenuation compensator; and
determine whether to detect the obstacle based on a difference between the first distance and the second distance calculated by a distance calculator.

3. The dual-band ultrasonic sensing apparatus according to claim 2, wherein the processor compensates for the attenuation through a variable amplification factor to which an attenuation coefficient corresponding to the difference in center frequency is applied.

4. The dual-band ultrasonic sensing apparatus according to claim 2, wherein the processor determines that the obstacle is detected when the difference between the first distance and the second distance is less than a set value.

5. The dual-band ultrasonic sensing apparatus according to claim 1, wherein the processor calculates the final distance by averaging the calculated first and second distances.

6. The dual-band ultrasonic sensing apparatus according to claim 1, wherein the first waveform transceiver comprises a bandpass filter adapted to filter a first center frequency.

7. The dual-band ultrasonic sensing apparatus according to claim 1, wherein the second waveform transceiver comprises a bandpass filter adapted to filter a second center frequency.

8. A method of controlling a dual-band ultrasonic sensing apparatus for vehicles, comprising:
transmitting and receiving, by a processor, ultrasound in a first center frequency band through a first waveform transceiver;
calculating, by the processor, a first distance based on a result of transmission and reception through the first waveform transceiver;
transmitting and receiving, by the processor, ultrasound in a second center frequency band higher than the first center frequency band through a second waveform transceiver;
compensating, by the processor, for signal attenuation due to a difference in center frequency based on a result of transmission and reception through the second waveform transceiver;
calculating, by the processor, a second distance based on a result of transmission and reception with the compensation for signal attenuation;
determining, by the processor, whether to detect an obstacle based on a difference value between the first distance and the second distance; and
calculating and outputting, by the processor, a final distance based on determining whether to detect an obstacle.

9. The method according to claim 8, wherein the processor compensates for the attenuation through a variable amplification factor to which an attenuation coefficient corresponding to the difference in center frequency is applied.

10. The method according to claim 8, wherein the processor determines that the obstacle is detected when the difference between the first distance and the second distance is less than a set value.

11. The method according to claim 8, wherein the processor calculates the final distance by averaging the first distance and the second distance.
